(19) United States
(12) Patent Application Publication
(10) Pub. No.: US 2009/0078758 A1
(43) Pub. Date: Mar. 26, 2009

(54) SYSTEMS AND METHODS FOR CARDLESS TRANSACTIONS USING A TELEPHONE NUMBER

(75) Inventor: Donald R. Crowell, Glassboro, NJ (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: First Data Corporation, Greenwood Village, CO (US)

(21) Appl. No.: 11/861,932

(22) Filed: Sep. 26, 2007

(51) Int. Cl. G06K 5/00

(52) U.S. Cl. 235/380

(57) ABSTRACT

This disclosure describes, generally, methods and systems for performing cardless financial transactions using a telephone number. The method may include registering a customer's telephone number with a financial account of the customer based at least in part on verification of the customer's identity and prompting the customer to enter into a cardless transaction. The method may further include receiving the entered telephone number and personal identification number (PIN). The method may further verify the entered telephone number by comparing it to the registered telephone number, and in response to verification of the entered telephone number, retrieve account information for the financial account. The method may further include verifying the entered PIN by comparing it to a corresponding PIN associated with the financial account, and granting access to the financial account based on verification of the entered telephone number and PIN.

### FIELD OF THE INVENTION

The present invention relates, in general, to cardless financial transactions, and more particularly, to performing a cardless transaction at an automated teller machine (ATM) using a telephone number for identification purposes.

### BACKGROUND

Presently, when a customer of a financial institution initiates a transaction for a financial account, the customer is required to present a card (e.g., an ATM card) associated with the account in order to complete the transaction. A typical transaction may involve the customer going to an ATM, inserting their ATM card into the machine, and entering their personal identification number (PIN). The customer is then presented with a series of prompts, and the customer selects the prompt that corresponds to the type of transaction to be completed.

This transaction process has several shortcomings. In particular, the customer must always carry a card associated with the account, which may be cumbersome, easily lost or stolen. If the customer forgets their card, completing a transaction can be very difficult or even impossible. Furthermore, as a customer opens additional accounts the number of cards they must carry around may become a burden. Accordingly, the present invention addresses these and other problems with current methods and systems.

### BRIEF SUMMARY

The tools provided by various embodiments of the invention include, without limitation, methods, systems, and/or software products. Mainly by way of example, a method might comprise one or more procedures, any or all of which are executed by a computer system. Correspondingly, an embodiment might comprise a computer system configured with instructions to perform one or more procedures in accordance with methods of the invention. Similarly, a computer program might comprise a set of instructions that are executable by a computer system (and/or a processor therein) to perform such operations. In many cases, such software programs are encoded on physical and/or tangible computer readable media (such as, merely by way of example, optical media, magnetic media, and/or the like).

An exemplary method of performing cardless financial transactions using a telephone number is described. The method might include registering a customer's telephone number with a financial account of the customer based at least in part on verification of the customer's identity and prompting the customer to enter into a cardless transaction, wherein the cardless transaction is accomplished by providing the registered telephone number and a corresponding PIN. The method may further receive the entered telephone number and PIN and verify the entered telephone number by comparing it to the registered telephone number.

The method may, in response to verification of the entered telephone number, retrieve account information for the financial account. The account information might include a corresponding PIN. The method may further verify the entered PIN by comparing it to the corresponding PIN associated with the financial account and grant access to the financial account based on verification of the entered telephone number and verification of the entered PIN.

In an alternate embodiment, a system for performing cardless financial transactions using a telephone number is described. The system might include an ATM which may be configured to prompt a customer to enter a telephone number registered with a corresponding financial account and to prompt the customer to enter a PIN and a transaction amount. The system could further include a database which may be configured to store an association between the telephone number and the financial account. The system may further include a financial institution network which may be configured to receive account verification requests, to transmit verification responses, and to process financial transactions.

The system may further include a processing center that is coupled with the ATM, the database and the financial institution network. The processing center may be configured to receive the entered telephone number and PIN and to verify the entered telephone number by comparing it to the telephone number stored in the database. The processing center may, in response to verifying the entered telephone number, retrieve account information for the financial account from the financial institution network. The account information may include a corresponding PIN. The processing center may further verify the entered PIN by comparing it to the corresponding PIN, and grant access to the financial account based on verification of the entered telephone number and verification of the entered PIN.

A machine-readable medium for performing cardless financial transactions using a telephone number is described. The machine-readable medium might include registering a customer's telephone number with a financial account of the customer based at least in part on verification of the customer's identity and prompting the customer to enter into a cardless transaction, wherein the cardless transaction is accomplished by providing the registered telephone number and a corresponding PIN. The machine-readable medium may further receive the entered telephone number and PIN and verify the entered telephone number by comparing it to the registered telephone number.

The machine-readable medium may, in response to verification of the entered telephone number, retrieve account information for the financial account. The account information might include a corresponding PIN. The machine-readable medium may further verify the entered PIN by comparing it to the corresponding PIN associated with the financial account and grant access to the financial account based on verification of the entered telephone number and PIN.

### BRIEF DESCRIPTION OF THE DRAWINGS

A further understanding of the nature and advantages of the present invention may be realized by reference to the remaining portions of the specification and the drawings wherein like reference numerals are used throughout the several drawings to refer to similar components. In some instances, a sublabel is associated with a reference numeral to denote one of multiple similar components. When reference is made to a reference numeral without specification to an existing sublabel, it is intended to refer to all such multiple similar components.

FIG. 1 is a process flow diagram illustrating registration of a telephone number to be used for financial transactions, in accordance with various embodiments of the invention.

FIG. 2 is a process flow diagram illustrating pre-staging of a cardless financial transaction, in accordance with various embodiments of the invention.

FIG. 3 is a process flow diagram illustrating executing a cardless financial transaction, in accordance with various embodiments of the invention.

FIG. 4 is a block diagram illustrating a system for implementing cardless financial transactions, in accordance with various embodiments of the invention.

FIG. 5 is a generalized schematic diagram illustrating a computer system, in accordance with various embodiments of the invention.

FIG. 6 is a block diagram illustrating a networked system of computers, which can be used in accordance with various embodiments of the invention.

### DETAILED DESCRIPTION OF THE INVENTION

While various aspects of embodiments of the invention have been summarized above, the following detailed description illustrates exemplary embodiments in further detail to enable one of skill in the art to practice the invention. In the following description, for the purposes of explanation, numerous specific details are set forth in order to provide a thorough understanding of the present invention. It will be apparent, however, to one skilled in the art that the present invention may be practiced without some of these specific details. In other instances, well-known structures and devices are shown in block diagram form. Several embodiments of the invention are described below, and while various features are ascribed to different embodiments, it should be appreciated that the features described with respect to one embodiment may be incorporated with another embodiment as well. By the same token, however, no single feature or features of any described embodiment should be considered essential to the invention, as other embodiments of the invention may omit such features.

According to aspects of the present invention, cardless financial transactions are provided in part by registering a customer's telephone number and using that number to complete the cardless transaction. For example, a customer may be able to register their cellular telephone number with a financial account in order to enable the completion of transactions for the account without needing their automated teller machine (ATM) card. The customer may further be able to call an interactive voice recognition (IVR) system, which verifies from the caller ID that the phone the customer is calling form is the registered phone number. The customer then, for example, may schedule a $100.00 withdrawal from their account.

The customer then can go to an ATM (or point-of-service (POS) device) and select a “cardless telephone number transaction” option. The customer can then enter their cellular phone number, their PIN and the withdrawal amount (i.e., $100.00), and upon verification, the customer may receive the funds without ever needing to present their ATM card.

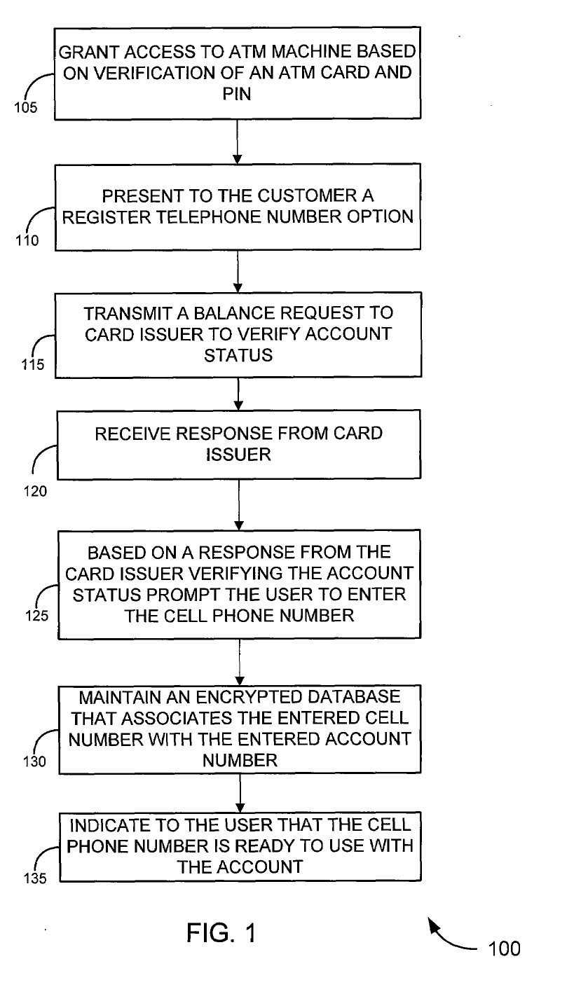

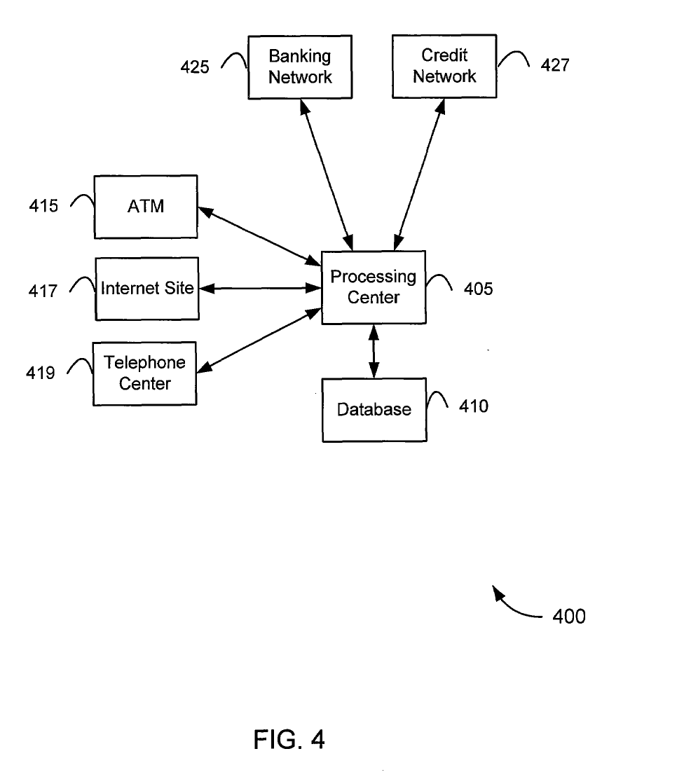

Turning now to FIG. 1 which illustrates one embodiment of method 100 for registering a telephone number to be used for financial transactions. In one embodiment, a customer may be presented with an interface at an ATM associated directly or indirectly with a financial institution. The customer may alternatively go to a branch office of the financial institution, or call in to an IVR system. Nonetheless, merely for the purpose of explanation, FIG. 1 will be illustrated in the context of an ATM (e.g., ATM 415 in FIG. 4), and one in the ordinary skill of the art would appreciate that either a branch office or an IVR system would also be appropriate. Alternatively, the registration process may occur when the financial account is initially activated.

In one embodiment an ATM is a multi-purpose kiosk that allow for money transfer service providers to reach more potential customers without the need for agents. The ATM provides customers with means for communicating electronically with money transfer service providers and/or third party intermediaries, and allows the service providers to collect funds, verify identifications, dispense funds, etc. A further description of such multi-purpose kiosks (e.g., ATMs) can be found in U.S. Patent Application Publication No. 2004/0039702 to Blair et. al, filed Aug. 20, 2002, which is incorporated by reference in its entirety and for any purpose.

At process block 105, based on verification of an ATM card and its associated PIN, the customer may be granted access to the ATM. In one embodiment, the ATM may display a graphical user interface (GUI) with a series of task options that may be selected by the customer. In one embodiment, the customer may be presented with a “register telephone number” option (process block 110). The registration of a telephone number may be used to provide the customer with cardless access for performing various financial transactions. In one embodiment, upon successful registration of the customer's telephone number, the customer may subsequently be able to access, for example, the ATM without inserting the ATM card into the machine (i.e., cardless access).

In an alternate embodiment, the registration of a customer's telephone number may be preformed using an IVR system or via a website. For example, the customer may call into the IVR system and after verification, the customer would be able to register their telephone number. Similarly, the customer could login to a website and verify their identity, and then provide the telephone number that they want to register.

In one embodiment, the customer may choose any valid telephone number to register with a financial account. However, according to an alternative embodiment, the telephone number may be required to have previously been associated with the financial account (e.g., a telephone number provided upon creation of the financial account). Furthermore, the telephone number may be any type of telephone number. For example, the telephone number may be a cellular number, a land line, voice over IP (VoIP) number, work number, etc.

In a further embodiment, before the telephone number can be registered for cardless access to the financial account, the number may need to be checked against phone records to verify that it is an active valid telephone number. In addition, the telephone number may also be checked to verify whether the name on the telephone number account matches the name on the financial account.

At process block 115, a balance request may be transmitted to the card issuer. In one embodiment, the balance request may be used by the financial institution to verify the financial account's status (e.g., that the account has sufficient funds and is in “good standing”). At process block 120, a response from the card issuer is received. If the response indicates that the account is not in “good standing,” the customer may not be able to register their telephone number. Alternatively, if the card issuer responds that the financial account is in “good standing”, the telephone registration process may continue.

At process block 125, based on a “good standing” response from the card issuer, the customer may then be prompted to enter the telephone number they wish to register with the financial account. As previously stated, the telephone number may itself also be verified. In one embodiment, the customer may use keys on an ATM keypad and/or touch screen to enter in the telephone number. Alternatively, the ATM may be configured to receive the telephone number and other commands audibly.

At process block 130, an encrypted database may be maintained (e.g., database 410 from FIG. 4); however, other storage structures and/or databases may also be maintained. Further, various encryption methods may be implemented (e.g., 128-bit data encryption standard (DES), triple DES (3DES), etc.). In one embodiment, the database may be used to associate the entered telephone number with the financial account. Accordingly, when the customer attempts to access their account using the cardless option, the financial account number associated with telephone number provided by the customer can quickly and efficiently be located.

At process block 135, a message may be displayed on an ATM display screen indicating to the customer that the telephone number has been successfully registered with the financial account. In the alternative, or in addition, the customer may receive a print out from the ATM indicating that the registration was successful. Furthermore, the customer may receive a call to the registered telephone number with a verification message. The message may be a live call, or alternatively may be an automated recording, a text message, a voice message, an electronic mail (email), etc. Consequently, upon successful registration of the telephone number, the customer may begin using the registered number to complete cardless transactions.

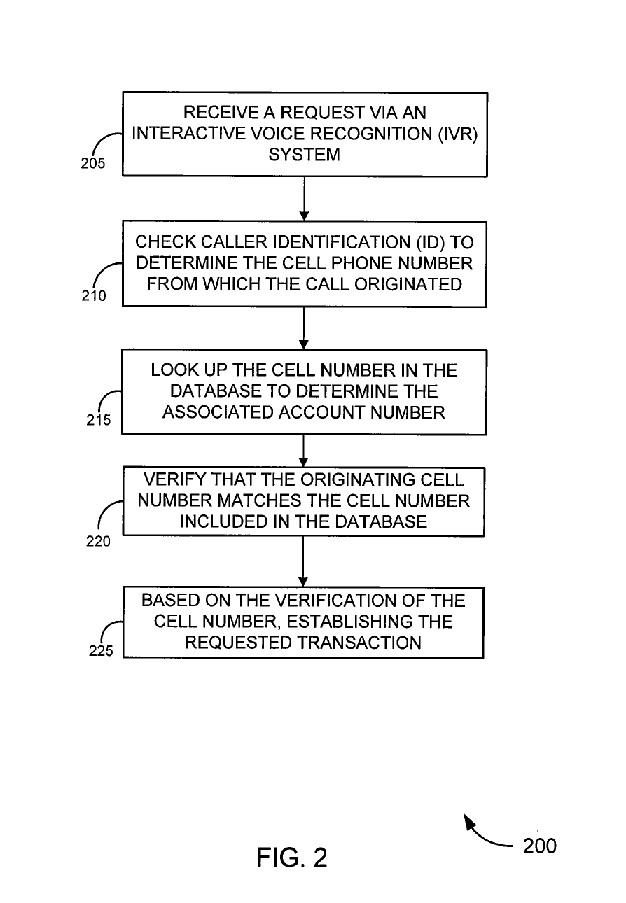

Turning now to FIG. 2 which illustrates one embodiment of method 200 for pre-staging a cardless financial transaction. In one embodiment, the pre-staging of a cardless financial transaction may be the process of setting up the transaction for execution at a later time. For example, at process block 205, a customer may call in to an IVR system and request a pre-staging of a financial transaction. Alternatively, the customer may call in to a call center and talk to a live customer representative or the customer may logon to an Internet site to set up the pre-staged financial transaction. The request may include a transaction amount (e.g., $100.00) and a transaction type (e.g., deposit, withdrawal, transfer, etc.). The IVR system may request additional information such as, the customer's name, the registered telephone number, mother's maiden name, current address, etc.

In one embodiment, at process block 210, the caller identification (ID) of the telephone which the customer is using to call into the IVR system may be checked. By using the caller ID number the system may then look up the caller ID number in the database to determine the associated account number (process block 215). Using the caller ID may add an additional layer of security because, in order for a fraudulent transaction to occur, the fraudulent actor would need to steal the telephone from the customer of the financial account. The check of the caller ID can at least verify that the person calling into the IVR system is in possession of the registered telephone.

At process block 220, the caller ID number is verified against the registered number in the database to determine whether there is a match. At process block 225, based on verification of the telephone number, the requested financial transaction may be established. The customer may receive verbal confirmation that the transaction has been established; however, alternatively, the customer may receive a text message, a voice message, an email, etc. confirming the establishment of the transaction.

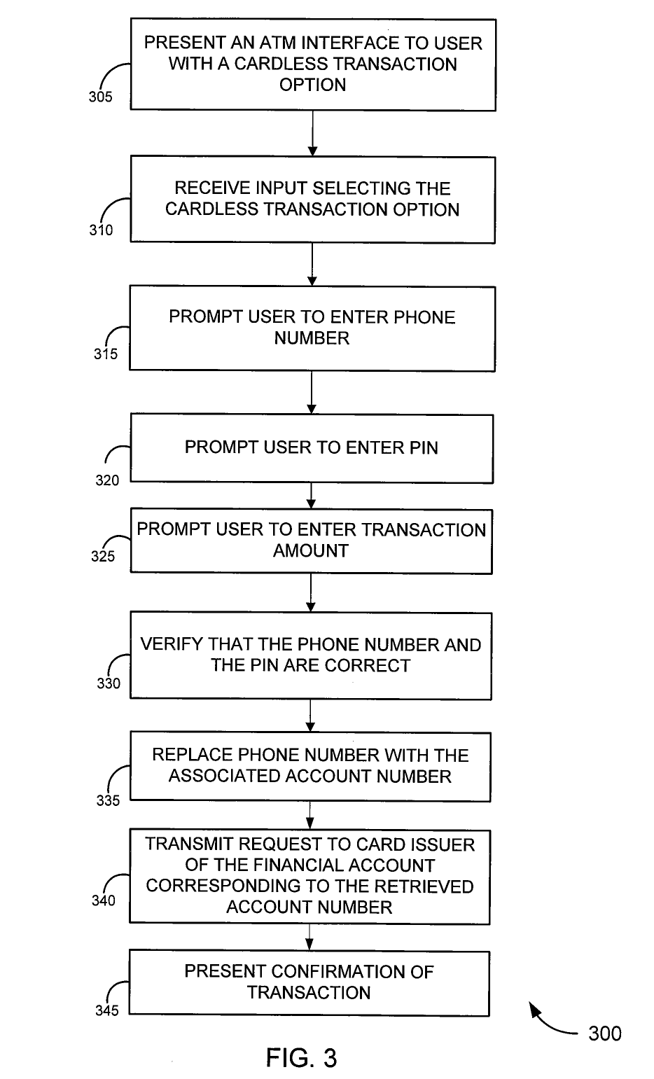

Now describing FIG. 3 which illustrates one embodiment of method 300 for executing a cardless financial transaction. After establishing a pre-staged transaction the customer may go to, for example, an ATM and be presented with a “cardless transaction” prompt option (process block 305). However, on an alternative embodiment, the customer may execute a cardless transaction without pre-staging the transaction. In either instance upon selection of the “cardless transaction” option (process block 310), the user may be presented with a prompt to enter the registered telephone number associated with the financial account (process block 315).

At process block 320, the customer may further be prompted to enter the PIN associated with the financial account. The PIN may be used for additional verification purposes. In one embodiment, for example, if the transaction was pre-staged, the customer may be prompted to enter in the transaction amount (e.g., $100.00) previously provided during the pre-staging process (process block 325). The transaction amount may further provide additional security by having the customer provide the amount at both the pre-staging process and the completion of the transaction.

At process block 330, the entered telephone number and PIN are verified to determine whether the combination is valid. If the combination cannot be verified, the customer may be notified and given another opportunity to re-enter both the telephone number and/or the PIN. Upon verification of the combination of the PIN and telephone number, the telephone number may then be replaced with the associated financial account number (process block 335). This replacing may occur by accessing the encrypted database and retrieving the record which corresponds to the registered telephone number. Then, extracting the account number stored in the retrieved record.

At process block 340, a request to the card issuer associated with the financial account may be transmitted. In one embodiment, the use of the telephone number by the customer to perform a cardless transaction is completely transparent to the card issuer because the card issuer is only transmitted the account number and PIN. The card issuer believes that the request is an ordinary request. As such, the card issuer responds to the request with either an approval or denial of the request. Accordingly, the customer is presented with confirmation or denial of the transaction request (process block 345).

Referring now to FIG. 4 which is a block diagram illustrating a system 400 for implementing cardless financial transactions, in accordance with various embodiments of the invention. FIG. 4 may be configured to execute any of the methods of FIGS. 1-3. In one embodiment, system 400 may include a processing center 405. Processing center 405 may be configured to receive requests from customers for registration of a telephone number for cardless transactions. Further, processing center 405 may also receive pre-staging requests and requests for execution of cardless transactions. In one embodiment, processing center 405 may be a central hub for all cardless transactions. Processing center 405 may upon receipt of a request, gather the needed information used to complete the requested transaction.

For example, processing center 405 may be coupled with ATM 415, Internet site 417 and telephone center 419. In one embodiment, processing center 405 may, for example, receive a cardless transaction request from ATM 415. Alternatively, processing center 405 may receive a transaction pre-staging request from telephone center 419 which is implements an IVR system, or processing center 405 may also receive a telephone number registration request from Internet site 417. Regardless of the request type and originating location of the request received by processing center 405, the request may be analyzed and the necessary information gathered to complete the request.

For example, if the request is a registration request, processing center 405 may access banking network 425 or credit network 427 in order to determine the status of the account associated with the request (i.e., determine if the account is in “good standing”). Furthermore, processing center 405 may access database 410 in order to transmit the registered telephone number for storage by database 410. In one embodiment, database 410 may create an entry which indicates that the entered telephone number is registered with the financial account.

In a further embodiment, if the request is a pre-staging request, processing center 405 may check the caller ID of the telephone being used to complete the request. Processing center 405 may further check database 410 to determine if the caller ID number and the number in the database match. Furthermore, processing center 405 may be configured to verify the combination of an entered telephone number and an entered PIN.

Processing center 405 may also, for example, replace the telephone number with the corresponding account number and transmit the request to the card issuer via banking network 425 and/or credit network 427. Processing center 405 may then receive responses from the card issuer and forward those responses to, for example, ATM 415 to be viewed by the customer. In one embodiment, processing center 405 and ATM 415 may be co-located together (i.e., processing center 405 and ATM 415 are at the same location or are located within the same computer system).

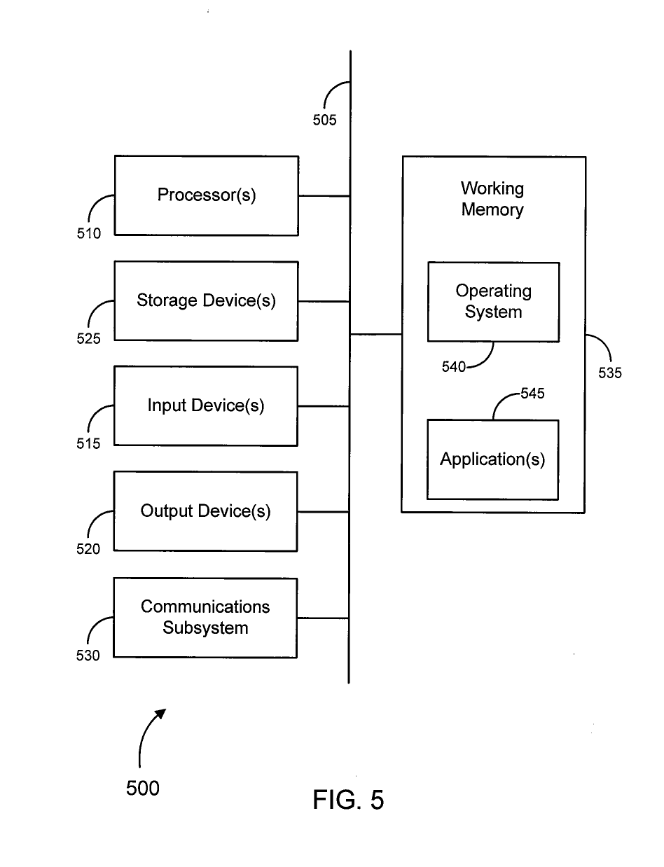

FIG. 5 provides a schematic illustration of one embodiment of a computer system 500 that can perform the methods of the invention, as described herein, and/or can function as, for example, processing center 405 or ATM 415. It should be noted that FIG. 5 is meant only to provide a generalized illustration of various components, any or all of which may be utilized as appropriate. FIG. 5, therefore, broadly illustrates how individual system elements may be implemented in a relatively separated or relatively more integrated manner.

The computer system 500 is shown comprising hardware elements that can be electrically coupled via a bus 505 (or may otherwise be in communication, as appropriate). The hardware elements can include one or more processors 510, including without limitation one or more general-purpose processors and/or one or more special-purpose processors (such as digital signal processing chips, graphics acceleration chips, and/or the like); one or more input devices 515, which can include without limitation a mouse, a keyboard and/or the like; and one or more output devices 520, which can include without limitation a display device, a printer and/or the like.

The computer system 500 may further include (and/or be in communication with) one or more storage devices 525, which can comprise, without limitation, local and/or network accessible storage and/or can include, without limitation, a disk drive, a drive array, an optical storage device, solid-state storage device such as a random access memory (“RAM”) and/or a read-only memory (“ROM”), which can be programmable, flash-updateable and/or the like. The computer system 500 might also include a communications subsystem 530, which can include without limitation a modem, a network card (wireless or wired), an infra-red communication device, a wireless communication device and/or chipset (such as a Bluetooth™ device, an 802.11 device, a WiFi device, a WiMax device, cellular communication facilities, etc.), and/or the like. The communications subsystem 530 may permit data to be exchanged with a network (such as the network described below, to name one example), and/or any other devices described herein. In many embodiments, the computer system 500 will further comprise a working memory 535, which can include a RAM or ROM device, as described above.

The computer system 500 also can comprise software elements, shown as being currently located within the working memory 535, including an operating system 540 and/or other code, such as one or more application programs 545, which may comprise computer programs of the invention, and/or may be designed to implement methods of the invention and/or configure systems of the invention, as described herein. Merely by way of example, one or more procedures described with respect to the method(s) discussed above might be implemented as code and/or instructions executable by a computer (and/or a processor within a computer). A set of these instructions and/or code might be stored on a computer readable storage medium, such as the storage device(s) 525 described above. In some cases, the storage medium might be incorporated within a computer system, such as the system 500. In other embodiments, the storage medium might be separate from a computer system (i.e., a removable medium, such as a compact disc, etc.), and or provided in an installation package, such that the storage medium can be used to program a general purpose computer with the instructions/code stored thereon. These instructions might take the form of executable code, which is executable by the computer system 500 and/or might take the form of source and/or installable code, which, upon compilation and/or installation on the computer system 500 (e.g., using any of a variety of generally available compilers, installation programs, compression/decompression utilities, etc.) then takes the form of executable code.

It will be apparent to those skilled in the art that substantial variations may be made in accordance with specific requirements. For example, customized hardware might also be used, and/or particular elements might be implemented in hardware, software (including portable software, such as applets, etc.), or both. Further, connection to other computing devices such as network input/output devices may be employed.

In one aspect, the invention employs a computer system (such as the computer system 500) to perform methods of the invention. According to a set of embodiments, some or all of the procedures of such methods are performed by the computer system 500 in response to processor 510 executing one or more sequences of one or more instructions (which might be incorporated into the operating system 540 and/or other code, such as an application program 545) contained in the working memory 535. Such instructions may be read into the working memory 535 from another machine-readable medium, such as one or more of the storage device(s) 525. Merely by way of example, execution of the sequences of instructions contained in the working memory 535 might cause the processor(s) 510 to perform one or more procedures of the methods described herein.

The terms “machine-readable medium” and “computer readable medium”, as used herein, refer to any medium that participates in providing data that causes a machine to operate in a specific fashion. In an embodiment implemented using the computer system 500, various machine-readable media might be involved in providing instructions/code to processor(s) 510 for execution and/or might be used to store and/or carry such instructions/code (e.g., as signals). In many implementations, a computer readable medium is a physical and/or tangible storage medium. Such a medium may take many forms, including but not limited to, non-volatile media, volatile media, and transmission media. Non-volatile media includes, for example, optical or magnetic disks, such as the storage device(s) 525. Volatile media includes, without limitation dynamic memory, such as the working memory 535. Transmission media includes coaxial cables, copper wire and fiber optics, including the wires that comprise the bus 505, as well as the various components of the communication subsystem 530 (and/or the media by which the communications subsystem 530 provides communication with other devices). Hence, transmission media can also take the form of waves (including without limitation radio, acoustic and/or light waves, such as those generated during radio-wave and infra-red data communications).

Common forms of physical and/or tangible computer readable media include, for example, a floppy disk, a flexible disk, hard disk, magnetic tape, or any other magnetic medium, a CD-ROM, any other optical medium, punchcards, papertape, any other physical medium with patterns of holes, a RAM, a PROM, an EPROM, a FLASH-EPROM, any other memory chip or cartridge, a carrier wave as described hereinafter, or any other medium from which a computer can read instructions and/or code.

Various forms of machine-readable media may be involved in carrying one or more sequences of one or more instructions to the processor(s) 510 for execution. Merely by way of example, the instructions may initially be carried on a magnetic disk and/or optical disc of a remote computer. A remote computer might load the instructions into its dynamic memory and send the instructions as signals over a transmission medium to be received and/or executed by the computer system 500. These signals, which might be in the form of electromagnetic signals, acoustic signals, optical signals and/or the like, are all examples of carrier waves on which instructions can be encoded, in accordance with various embodiments of the invention.

The communications subsystem 530 (and/or components thereof) generally will receive the signals, and the bus 505 then might carry the signals (and/or the data, instructions, etc., carried by the signals) to the working memory 535, from which the processor(s) 505 retrieves and executes the instructions. The instructions received by the working memory 535 may optionally be stored on a storage device 525 either before or after execution by the processor(s) 510.

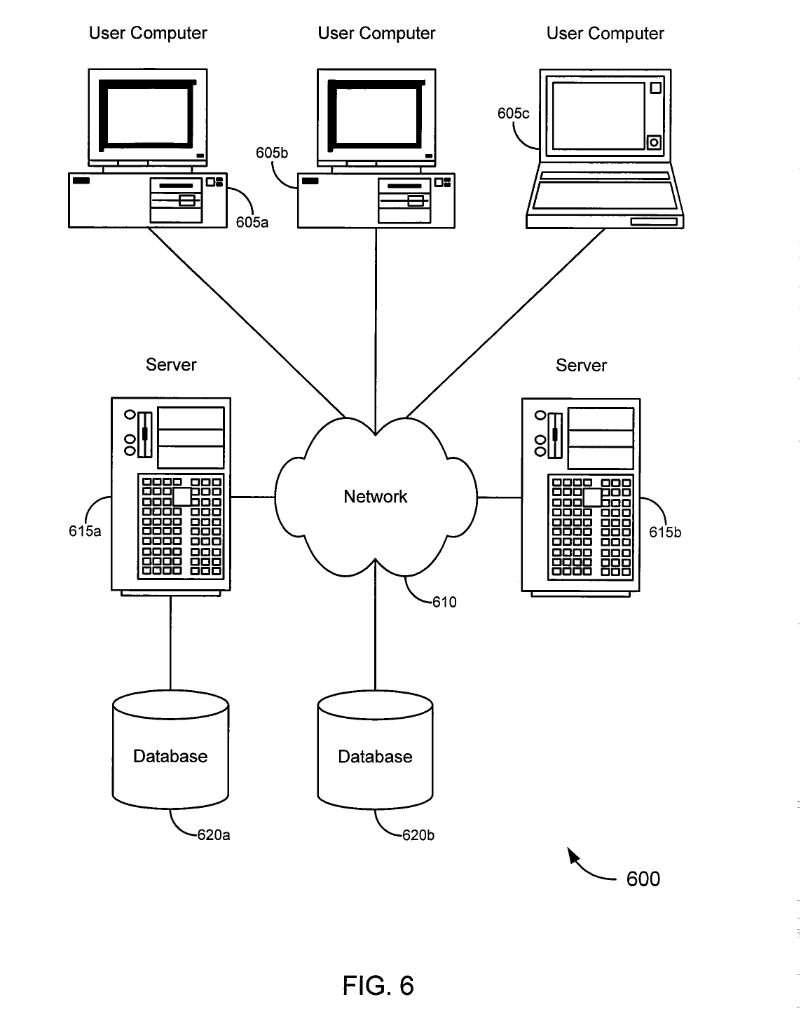

A set of embodiments comprises systems for performing cardless financial transactions using a phone number. Merely by way of example, FIG. 6 illustrates a schematic diagram of a system 600 that can be used in accordance with one set of embodiments. The system 600 can include one or more user computers 605. The user computers 605 can be general purpose personal computers (including, merely by way of example, personal computers and/or laptop computers running any appropriate flavor of Microsoft Corp.'s Windows™ and/or Apple Corp.'s Macintosh™ operating systems) and/or workstation computers running any of a variety of commercially-available UNIX™ or UNIX-like operating systems. These user computers 605 can also have any of a variety of applications, including one or more applications configured to perform methods of the invention, as well as one or more office applications, database client and/or server applications, and web browser applications. Alternatively, the user computers 605 can be any other electronic device, such as a thin-client computer, Internet-enabled mobile telephone, and/or personal digital assistant (PDA), capable of communicating via a network (e.g., the network 610 described below) and/or displaying and navigating web pages or other types of electronic documents. Although the exemplary system 600 is shown with three user computers 605, any number of user computers can be supported.

Certain embodiments of the invention operate in a networked environment, which can include a network 610. The network 610 can be any type of network familiar to those skilled in the art that can support data communications using any of a variety of commercially-available protocols, including without limitation TCP/IP, SNA, IPX, AppleTalk, and the like. Merely by way of example, the network 610 can be a local area network (“LAN”), including without limitation an Ethernet network, a Token-Ring network and/or the like; a wide-area network (WAN); a virtual network, including without limitation a virtual private network (“VPN”); the Internet; an intranet; an extranet; a public switched telephone network (“PSTN”); an infra-red network; a wireless network, including without limitation a network operating under any of the IEEE 802.11 suite of protocols, the Bluetooth™ protocol known in the art, and/or any other wireless protocol; and/or any combination of these and/or other networks.

Embodiments of the invention can include one or more server computers 615. Each of the server computers 615 may be configured with an operating system, including without limitation any of those discussed above, as well as any commercially (or freely) available server operating systems. Each of the servers 615 may also be running one or more applications, which can be configured to provide services to one or more clients 605 and/or other servers 615.

Merely by way of example, one of the servers 615 may be a web server, which can be used, merely by way of example, to process requests for web pages or other electronic documents from user computers 605. The web server can also run a variety of server applications, including HTTP servers, FTP servers, CGI servers, database servers, Java™ servers, and the like. In some embodiments of the invention, the web server may be configured to serve web pages that can be operated within a web browser on one or more of the user computers 605 to perform methods of the invention.

The server computers 615, in some embodiments, might include one or more application servers, which can include one or more applications accessible by a client running on one or more of the client computers 605 and/or other servers 615. Merely by way of example, the server(s) 615 can be one or more general purpose computers capable of executing programs or scripts in response to the user computers 605 and/or other servers 615, including without limitation web applications (which might, in some cases, be configured to perform methods of the invention). Merely by way of example, a web application can be implemented as one or more scripts or programs written in any suitable programming language, such as Java™, C, C#™ or C++, and/or any scripting language, such as Perl, Python, or TCL, as well as combinations of any programming/scripting languages. The application server(s) can also include database servers, including without limitation those commercially available from Oracle™, Microsoft™, Sybase™, IBM™ and the like, which can process requests from clients (including, depending on the configuration, database clients, API clients, web browsers, etc.) running on a user computer 605 and/or another server 615. In some embodiments, an application server can create web pages dynamically for displaying the information in accordance with embodiments of the invention, such as a web interface for internet site 417 (FIG. 4) used to complete cardless financial transactions. Data provided by an application server may be formatted as web pages (comprising HTML, Javascript, etc., for example) and/or may be forwarded to a user computer 605 via a web server (as described above, for example). Similarly, a web server might receive web page requests and/or input data from a user computer 605 and/or forward the web page requests and/or input data to an application server. In some cases a web server may be integrated with an application server.

In accordance with further embodiments, one or more servers 615 can function as a file server and/or can include one or more of the files (e.g., application code, data files, etc.) necessary to implement methods of the invention incorporated by an application running on a user computer 605 and/or another server 615. Alternatively, as those skilled in the art will appreciate, a file server can include all necessary files, allowing such an application to be invoked remotely by a user computer 605 and/or server 615. It should be noted that the functions described with respect to various servers herein (e.g., application server, database server, web server, file server, etc.) can be performed by a single server and/or a plurality of specialized servers, depending on implementation-specific needs and parameters.

In certain embodiments, the system can include one or more databases 620. The location of the database(s) 620 is discretionary: merely by way of example, a database 620a might reside on a storage medium local to (and/or resident in) a server 615a (and/or a user computer 605). Alternatively, a database 620b can be remote from any or all of the computers 605, 615, so long as it can be in communication (e.g., via the network 610) with one or more of these. In a particular set of embodiments, a database 620 can reside in a storage-area network (“SAN”) familiar to those skilled in the art. (Likewise, any necessary files for performing the functions attributed to the computers 605, 615 can be stored locally on the respective computer and/or remotely, as appropriate.) In one set of embodiments, the database 620 can be a relational database, such as an Oracle™ database, that is adapted to store, update, and retrieve data in response to SQL-formatted commands. The database might be controlled and/or maintained by a database server, as described above, for example.

While the invention has been described with respect to exemplary embodiments, one skilled in the art will recognize that numerous modifications are possible. For example, the methods and processes described herein may be implemented using hardware components, software components, and/or any combination thereof. Further, while various methods and processes described herein may be described with respect to particular structural and/or functional components for ease of description, methods of the invention are not limited to any particular structural and/or functional architecture but instead can be implemented on any suitable hardware, firmware and/or software configuration. Similarly, while various functionality is ascribed to certain system components, unless the context dictates otherwise, this functionality can be distributed among various other system components in accordance with different embodiments of the invention.

Moreover, while the procedures comprised in the methods and processes described herein are described in a particular order for ease of description, unless the context dictates otherwise, various procedures may be reordered, added, and/or omitted in accordance with various embodiments of the invention. Moreover, the procedures described with respect to one method or process may be incorporated within other described methods or processes; likewise, system components described according to a particular structural architecture and/or with respect to one system may be organized in alternative structural architectures and/or incorporated within other described systems. Hence, while various embodiments are described with—or without—certain features for ease of description and to illustrate exemplary features, the various components and/or features described herein with respect to a particular embodiment can be substituted, added and/or subtracted from among other described embodiments, unless the context dictates otherwise. Consequently, although the invention has been described with respect to exemplary embodiments, it will be appreciated that the invention is intended to cover all modifications and equivalents within the scope of the following claims.

What is claimed is:

1. A method of performing cardless financial transactions using a telephone number, the method comprising:
registering a customer's telephone number with a financial account of the customer;
prompting the customer to enter into a cardless transaction, wherein the cardless transaction is accomplished by providing the registered telephone number and a personal identification number (PIN);
receiving the entered telephone number and PIN;
verifying the entered telephone number by comparing the entered telephone number with the registered telephone number;
in response to verification of the entered telephone number, retrieving account information for the financial account;
verifying the entered PIN by comparing the entered PIN with a corresponding PIN associated with the financial account; and
granting access to the financial account based on verification of the entered telephone number and verification of the entered PIN.

2. The method of claim 1, further comprising:
receiving a call to an interactive voice recognition (IVR) system requesting approval for a financial transaction associated with the financial account prior to prompting th customer to enter into the cardless transaction; and
verifying the customer based on comparing caller identification (ID) information from the telephone the customer made the call from with the registered telephone number.

3. The method of claim 2, further comprising in response to verification of the customer, receiving an amount associated with the financial transaction request.

4. The method of claim 3, wherein the granting of access to the financial account is further based on verification of the amount associated with the financial transaction request.

5. The method of claim 1, wherein the registering of the customer's telephone number comprises:
transmitting a request to a financial institution associated with the financial account, wherein the request is to verify the financial account's status;
receiving a response from the financial institution verifying the financial account's status; and
in response to the verification of the financial account's status, prompting the customer to enter the telephone number to be registered with the financial account.

6. The method of claim 5, wherein the registering of the customer's telephone number further comprises:
associating, in an encrypted database, the telephone number with an account number of the financial account; and
indicating to the customer that the telephone number has been successfully registered with the financial account.

7. The method of claim 6, further comprising:
accessing the encrypted database to retrieve the telephone number and the account number; and
replacing the telephone number with the account number before transmitting the request to the financial institution.

8. The method of claim 7, wherein transmissions with the financial institution are encrypted.

9. The method of claim 1, wherein the telephone number is a cellular telephone number.

10. The method of claim 1, wherein the method is executed by at least one of an automated teller machine (ATM), a point-of-service (POS) device, an IVR system, a website, and a branch location.

11. A system for performing cardless financial transactions using a telephone number, the system comprising:
an automated teller machine (ATM) having a display screen that is configured to prompt a customer to enter a telephone number registered with a corresponding financial account and to prompt the customer to enter a personal identification number (PIN);
a database configured to store an association between the telephone number and the financial account;
a financial institution network configured to receive account verification requests, to transmit verification responses, and to process financial transactions; and
a processing center coupled with the ATM, the database and the financial institution network, configured to receive the entered telephone number and PIN, to verify the entered telephone number by comparing it to the telephone number stored in the database, in response to verifying the entered telephone number, to retrieve account information for the financial account from the financial institution network, to verify the entered PIN by comparing it to a corresponding PIN, and to grant access to the financial account based on verification of the entered telephone number and PIN.

12. The system of claim 11, further comprising an interactive voice recognition (IVR) system coupled with the processing center, configured to receive a call from the customer requesting approval for the financial transaction associated with the financial account and to verify the customer based on comparing caller identification (ID) information for the telephone the customer made the call from with the registered telephone number.

13. The system of claim 12, wherein the IVR system is further configured in response to verification of the customer, to receive an amount associated with the financial transaction request.

14. The system of claim 13, wherein the granting of access to the customer by the processing center is further based on verification of the amount associated with the financial transaction request.

15. The system of claim 13, wherein information stored in the database is encrypted.

16. The system of claim 11, wherein the ATM and the processing center are co-located together.

17. A machine-readable medium for performing cardless financial transactions using a telephone number, having sets of instructions which, when executed by a machine, cause the machine to:
register a customer's telephone number with a financial account of the customer based at least in part on verification of the customer's identity;
prompt the customer to enter into a cardless transaction, wherein the cardless transaction is accomplished by providing the registered telephone number and a personal identification number (PIN);
receive the entered telephone number and PIN;
verify the entered telephone number by comparing the entered telephone number with to the registered telephone number;
in response to verification of the entered telephone number, retrieve account information for the financial account;
verify the entered PIN by comparing the entered PIN with a corresponding PIN associated with the financial account; and
grant access to the financial account based on verification of the entered telephone number and PIN.

18. The machine-readable medium of claim 17, wherein the registering of the customer's telephone number further comprises a set of instructions which, when executed by the machine cause the machine to:
transmit a request to a financial institution associated with the financial account, wherein the request is to verify the financial account's status;
receive a response from the financial institution verifying the financial account's status; and
in response to the verification of the financial account's status, prompt the customer to enter the telephone number to be registered with the financial account.

19. The machine-readable medium of claim 18, wherein the registering of the customer's telephone number further comprises a set of instructions which, when executed by the machine cause the machine to:
associate, in an encrypted database, the telephone number with an account number of the financial account; and
indicate to the customer that the telephone number has been successfully registered with the financial account.

20. The machine-readable medium of claim 19, wherein the sets of instructions which, when executed by the machine, further cause the machine to:
access the encrypted database to retrieve the telephone number and the account number; and
replace the telephone number with the account number before transmitting the request to the financial institution.
